(19) United States
(12) Patent Application Publication
(10) Pub. No.: US 2009/0242469 A1
(43) Pub. Date: Oct. 1, 2009

(54) Filter Assembly for Cleaning Fluids by Way of an Indexing Cloth Filter

(76) Inventor: Gerry Calabrese, Fort Lauderdale, FL (US)

Correspondence Address: LERNER GREENBERG STEMER LLP, P O BOX 2480, HOLLYWOOD, FL, 33022-2480, US

(21) Appl. No.: 12/415,541

(22) Filed: Mar. 31, 2009

Related U.S. Application Data
(60) Provisional application No. 61/041,353, filed on Apr. 1, 2008.

(51) Int. Cl. B01D 33/00; A01K 63/04; B01D 46/18

(52) U.S. Cl. 210/122; 210/167.21; 210/400; 55/354

(57) ABSTRACT

A filter assembly has an inlet for supplying a fluid to be cleaned and an outlet for returning cleaned fluid. A cloth filter is disposed between the inlet and the outlet. The filter has a web of filter cloth wound on a supply roll and guided along an effective filter area to a takeup roll for receiving clogged filter web. A motor is connected to the takeup roll for rotating the takeup roll and for transporting the filter cloth forward across the effective filter area. A switching device is connected to selectively energize the motor and to index the filter cloth forward by an amount less than a length of the effective filter area.

### CROSS-REFERENCE TO RELATED APPLICATION

This application claims the priority, under 35 U.S.C. §119(e) of provisional patent application No. 61/041,353, filed on Apr. 1, 2008.

### BACKGROUND OF THE INVENTION

### Field of the Invention

The invention relates to fluid filters. More specifically, the invention relates to mechanical filters for air and for liquids, such as water. The primary fields of application are for aquarium water filtration and for circulating air stream filtration.

Water filtering systems are known with manual, semi-automatic, or automatic cleaning systems for the filter element. In an aquarium context, a normal filter will continue to accumulate waste until it is clogged. This usually takes long enough so that the waste accumulated breaks down and adds to the dissolved organics in the water.

Similarly, air filters gather dirt and allergens continuously passing relatively clean air through captured dirt, dust and allergens.

### BRIEF SUMMARY OF THE INVENTION

It is an object of the invention to provide a fluid filter assembly, which overcomes a variety of disadvantages of the prior art devices and methods of the general type and which provides for a simple yet efficient filtration assembly that may be provided at low cost, yet provides for fully automatic operation.

With the foregoing and other objects in view there is provided, in accordance with the invention, a filter assembly, comprising:

a inlet for supplying a fluid to be cleaned;

an outlet for returning cleaned fluid;

a filter disposed between the inlet and the outlet, the filter including a web of filter cloth wound on a supply roll and guided along an effective filter area to a takeup roll for receiving clogged filter web;

a motor connected to the takeup roll for rotating the takeup roll and for transporting the filter cloth forward across the effective filter area; and

a switching device connected to the motor for selectively energizing the motor and for indexing the filter cloth forward by an amount less than a length of the effective filter area.

In contrast with the prior art systems, wherein the fluid stream to be cleaned is forced through the partially clogged filter, the novel system moves the waste out of the stream of flow eliminating the waste from dissolving in the water. Similarly, in the air cleaning context, the novel system moves the captured dirt and dust and allergens out of the main stream, possibly eliminating contamination of the new air.

In accordance with an added feature of the invention, the filter assembly includes a filter housing having a wall formed with the inlet and a bottom wall formed with one or more throughflow openings disposed geodetically below the inlet, a collection container disposed geodetically below the bottom wall and having a wall formed with the outlet, and wherein the effective filter area is defined above the one or more throughflow openings, and the filter cloth is guided to cover the one or more throughflow openings and filter a liquid flowing through the bottom wall.

This filter assembly is particularly well suited for connection into a water cycle of an aquarium and for cleaning the aquarium water. Both fresh-water and saltwater aquariums may connected.

In accordance with an additional feature of the invention, the switching device is a float switch disposed to be responsive to a rising water level in the filter housing beyond a given threshold level, and configured to energize the motor for indexing the filter cloth forward by an amount less than a fifth of the length of the effective filter area before de-energizing the motor.

Advantageously, the switching device is configured to energize the motor for indexing the filter cloth forward by an amount less than a tenth of the length of the effective filter area before de-energizing the motor.

In an alternative implementation of the filter assembly, the filter cloth is configured to filter particles out of an air flow and the filter assembly is incorporated in an air handler of an air conditioning system.

Preferably, the filter cloth is rated for filtering particles down to 10 microns or even down to 0.5 microns.

In sum, the filter assembly (to be marketed as the “Sea Visions C.A.D.S cloth filter”) is an auto-indexing filter for entrapping foreign material out of fluids, such as water, brine, solvents, or air. The system can target a specific contaminate such as oil, dirt, fiber, metal, etc. The filter assembly is advantageously provided in the form of a component unit that incorporates an indexing system to wind a new section of cloth when the cloth gets clogged or dirty. The cloth can be any number of materials, including rayon, cotton, dacron, polyethylene or a myriad of fibers or hybrid fibers. In this context, the term “cloth” is used to indicate any number of fabrics or non-wovens that could be used as a filter medium. The system can be scaled up or down for any flow rates, pressures or liquid consistencies and viscosities.

The filter receives a new clean cloth surface for the mixture to pass through until it again becomes clogged, thus raises the water level tripping the level sensor which in turn powers the gear motor to move the cloth again.

This cycle repeats itself continuously until the roll is used up. At that point the influent water can be turned off or bypassed until the cloth roll is replaced. The tripping mechanism can also be a pressure sensor or any other mechanism that would detect a flow restriction through the cloth. The filter can be used as a gravity feed system or can be put under pressure to increase flow through the cloth.

The housing or filter support can be made of any structural material. The housing will insure that the new cloth reel is oriented parallel to the take up cloth reel. This ensures that the cloth winds up on the used side evenly. The reel or reels can incorporate tensioners to ensure tight, uniform, and even rollup of the old or used cloth.

Other features which are considered as characteristic for the invention are set forth in the appended claims.

Although the invention is illustrated and described herein as embodied in a fluid filter assembly, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a diagrammatic cross section taken through a filter assembly according to the invention for an aquarium;

FIG. 2 is a perspective image of a filter unit for an aquarium system;

FIG. 3 is a partial plan view onto the bottom wall of the filter assembly housing; and

FIG. 4 is a diagrammatic longitudinal section taken through an air handler box of an air conditioning system.

### DETAILED DESCRIPTION OF THE INVENTION

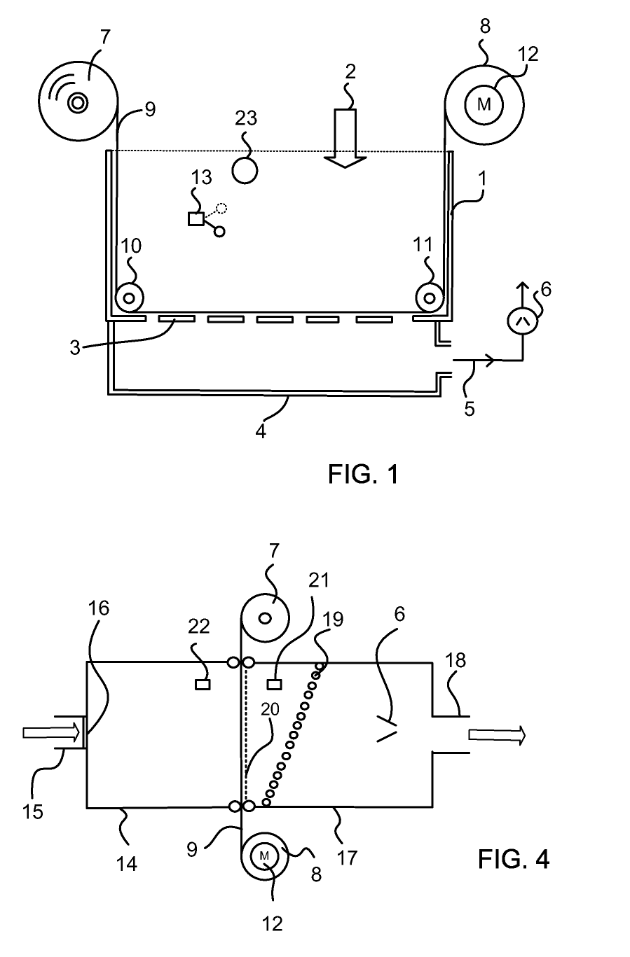

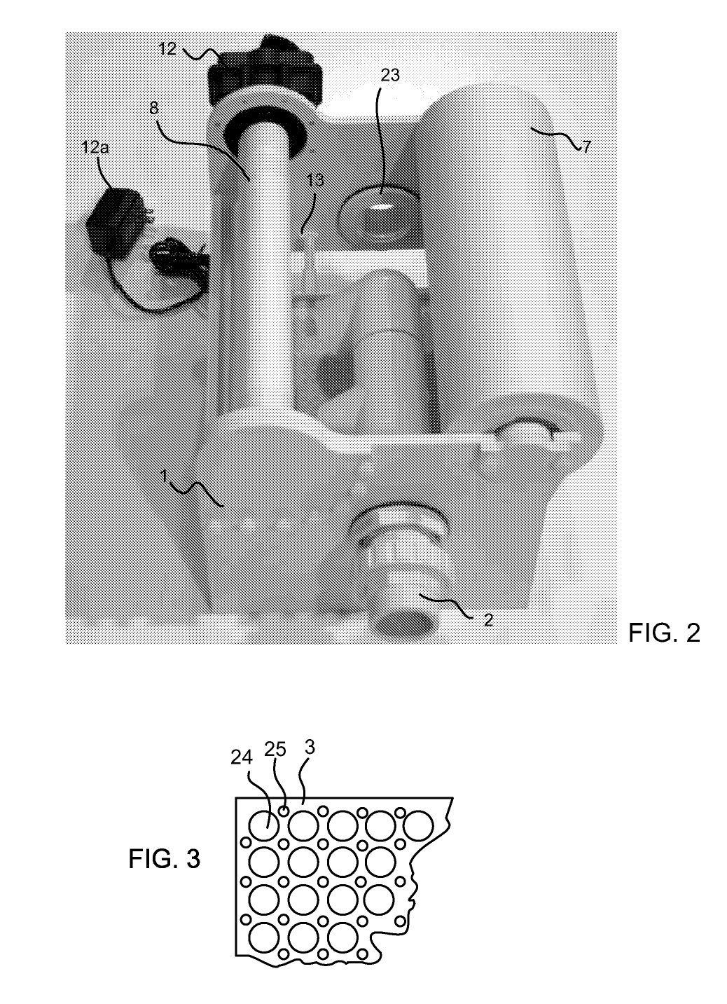

Referring now to the figures of the drawing in detail and first, particularly, to FIG. 1 thereof, there is seen a simplified cross section taken through a water filtration system for an aquarium tank. The filter assembly includes a filter box 1 which receives a water supply stream 2 with water to be cleaned. The bottom wall 3 of the filter box 1 is formed with a multiplicity of through holes, through which the water flows, in gravity flow, to a return collection container 4. From there the water stream is pumped in a return pipe 5 back into the aquarium tank. The water circulation may be driven by a pump 6 that is connected in the return pipe 5.

A filter cloth supply roll 7 is disposed at one side of the filter box and a pickup or takeup roll 8 is disposed on the opposite side. Filter cloth 9 extends from the supply roll 7, past deflection rolls 10, 11, to the takeup roll 8. The width of the web of filter is adapted to the filter box. In the context of an aquarium filter, the web may be approximately 30 cm (12 inches) wide. The roll 8 is driven by a motor 12 (preferably a gear motor), which is connected to rotate and index the roll 8 forward and thus to pick up filter cloth and to pull on and rotate the supply roll 7. In the context of a water filter, the motor may be a relatively small motor, as the roll 8 may be driven with a torque of, say, 0.6 to 3 Nm (1 to 5 ft-lbs).

The motor 12 is energized under the control of a float switch 13. When the filter cloth 9 extending between the deflection rollers 10, 11 becomes clogged, the water does not sufficiently drain through the bottom wall 3 and the water level rises. Upon reaching the level of the float switch 13, the water lifts the float and thus triggers and energizes the motor 12. As the motor rotates the takeup roll 8, the filter cloth is indexed forward and the water is once more allowed to properly drain through the bottom wall 3. As a result, the water level recedes, the float of the float switch 13 is lowered, and the motor 12 is turned off. The float switch 13, therefore, by measuring and reacting to a rise in the water level functions as a backpressure response controller. The float switch 13 measures and reacts to the increased clogging of the effective filter (i.e., the portion of the filter cloth 9 extending between the rolls 10 and 11).

There is also provided an overflow opening 23 which allows the water to bypass the filter should the system fail for any reason. The overflow opening empties either into the box 4 or it branches into the return line 5.

The water supply stream 2 is laden with particulate matter in a variety of sizes. The filter cloth is adapted accordingly. For instance, the water may be laden with relatively large objects, such as fish scales or fish bone parts during a feed cycle, while the particles in the supply stream 2 become increasingly smaller during a regular pumping cycle. Typical filter cloth for use in the context of an aquarium will be 100 micron rated cloth. That is, particles of a size larger than 100 microns are ensnared by the cloth and smaller particles are allowed to pass through.

The inventor, however, discovered an unexpected phenomenon and benefit during the testing of the device. Filter cloth that is rated at 100 microns is sufficient to filter out relatively large particles, but it will not filter out very small particles that “cloud” the aquarium water. On continued use, the effective filter becomes laden and the filter openings become smaller. In effect, the filter becomes increasingly “fine” and the rated filter number decreases substantially below 50 microns and down to about 20−10 microns. At that point, the water flow and filter throughput is reduced to such an extent that the water level inside the box 1 rises to switch the float switch and to turn on the motor 12. The motor 12 stays on until it is turned off (i.e., de-energized) by the float switch 13. Unexpectedly, this does not require a full forward index of the cloth. Instead, it is sufficient for the motor 12 to move the cloth forward by only a small distance until the water escape flow becomes great enough to lower the water level below the float and to turn off the motor 12.

By way of example, in a box with a footprint of 30×30 cm (12×12 inches), forward indexing by only approximately 2.5 cm (1 inch) during a motor-on period of approximately 1.0 to 3.0 seconds was found sufficient to lower the water level such that the motor 12 was turned off by the float switch 13. The motor 12 would then be triggered sporadically. As a result of this partial forward indexing, the aquarium tank water was remarkably clear. The water appeared as though it was filtered through a filter that was rated better than 10 to 20 microns. As best understood, the partial indexing triggered a slight realignment of the filter-clogging particles and thus caused the filter openings to increase slightly. The partial indexing thus causes the “filter rating” to remain as close as possible to the maximum rating for the specific application. Rated filter cloth of, say, 200 microns is thus “improved” to its highest possible rating, whereupon it fluctuates—due to the sporadic partial indexing motion—about the maximum rating of, say, 10 to 20 microns.

FIG. 2 illustrates a filter assembly unit in a perspective view. The inflow 2 empties into the filter box 1 by way of two pipe openings. The filter box 1 is integrally formed of PVC or a similar material. The motor 12 is a 12 VAC motor and the power converter 12a and the connecting cable are illustrated as well. A full supply of 100 micron filter cloth is ready on the supply roll 7 for transfer to the takeup roll 8.

The bottom wall 3 is formed with openings to allow the water to efficiently drain into the return collection container 4. In addition, the wall 3 provides the necessary support for the filter cloth 9 in the region of the effective filter area. As shown, there is provided a grid of large openings 24 and small openings 25. The intermediate bridges remaining between the openings 24, 25 form the support structure for the cloth 9. The ratio between open and closed area is approximately 3:1, that is, the bottom wall has openings taking up about 75% of the area.

Referring now to FIG. 4, the foregoing concepts also apply to an air circulation and cleaning system. Here, there is illustrated an air handler box of an air conditioning system. The view may be understood as a top plan or as a side view. Air enters into an air intake header 14 through an intake vent 15. The intake vent 15 may be provided with a coarse air filter 16, which ensnares relatively large particles such as lint, heavy dust, and the like. From there, the air is aspirated into a distributor box 17 by a pump 6 (typically, one or more squirrel pumps), from where it is distributed to one or more ducts 18. The air is drawn through a set of heat exchange coils 19 which cool the stream of air. Just prior to impinging on the coils 19, the air stream is cleaned by a filter assembly according to the invention.

Filter cloth 9 extends between a supply roll 7 and a takeup roll 8. Here, it will be understood that the filter has a considerably higher filter rating such as, for example, between 0.5 and 20 microns. The filter cloth backs up against a screen 20, which ensures that the filter remains relatively taut between the supply and takeup rolls 7, 8 without requiring any means that torque the two rolls relative to one another.

A downstream pressure gauge 21 measures the air pressure in the air box 17 just downstream of the filter 9. An upstream pressure gauge 22 measures the air pressure in the air box 14 upstream of the filter 9. The two measurement signals from the pressure gauges 21 and 22 are continuously compared with one another. The pressure difference Δp between the two is a directly proportional indication of the clogging of the filter 9. The simplest implementation of the differential pressure measurement is by way of a differential transducer, which replaces the two individual gauges 21, 22. The pressure difference thus measured is proportional to the flow velocity and to the volumetric flow.

When the pressure difference exceeds a specified amount, the motor 12 is triggered and the cloth 9 is indexed forward from the supply roll 7 onto the takeup roll 8. Dust particles and other dirt that has been caught in the filter, is thereby collected on the takeup roll 8. A depletion sensor 23 is provided so as to provide a warning signal or an indication that the filter supply has been depleted and that a new roll should be provided. The depletion sensor 23 may be a simple rider switch, for example, or it may be a two-position switch capable of providing an early warning (i.e., that the supply is nearing its end) and providing an indication that the supply has been used up. While the depletion sensor 23 indicates that the supply roll 7 is empty, the motor 12 cannot be energized.

By way of example, a suitable motor 12 to be used for the water filter application is a Jandy Valve Actuator, Model JVA 2444 (gear reduction, 24 VAC, 0.75 amp) by Jandy Pool Products, Inc. of California, which produces about 150 inch pounds of torque at 1 rpm. A suitable filter is sold by Great Lakes Filters of Hillsdale, Mich.

1. A filter assembly, comprising:
an inlet for supplying a fluid to be cleaned;
an outlet for returning cleaned fluid;
a filter disposed between said inlet and said outlet, said filter including a web of filter cloth wound on a supply roll and guided along an effective filter area to a takeup roll for receiving clogged filter web;
a motor connected to said takeup roll for rotating said takeup roll and for transporting said filter cloth forward across said effective filter area; and
a switching device connected to said motor for selectively energizing said motor and for indexing said filter cloth forward by an amount less than a length of said effective filter area.

2. The filter assembly according to claim 1, which comprises a filter housing having a wall formed with said inlet and a bottom wall formed with one or more throughflow openings disposed geodetically below said inlet, a collection container disposed geodetically below said bottom wall and having a wall formed with said outlet, and wherein said effective filter area is defined above said one or more throughflow openings, and said filter cloth is guided to cover said one or more throughflow openings and filter a liquid flowing through said bottom wall.

3. The filter assembly according to claim 2 connected into a water cycle of an aquarium and configured to clean the aquarium water.

4. The filter assembly according to claim 2, wherein said switching device is a float switch disposed to be responsive to a rising water level in said filter housing beyond a given threshold level, and configured to energize said motor for indexing said filter cloth forward by an amount less than a fifth of the length of said effective filter area before de-energizing said motor.

5. The filter assembly according to claim 4, wherein said switching device is configured to energize said motor for indexing said filter cloth forward by an amount less than a tenth of the length of said effective filter area before de-energizing said motor.

6. The filter assembly according to claim 1, wherein said filter cloth is configured to filter particles out of an air flow and the filter assembly is incorporated in an air handler of an air conditioning system.

7. The filter assembly according to claim 6, wherein said filter cloth is rated for filtering particles down to 10 microns.

8. The filter assembly according to claim 6, wherein said filter cloth is rated for filtering particles down to 0.5 microns.
